(19) United States
(12) Patent Application Publication
(10) Pub. No.: US 2017/0371776 A1
(43) Pub. Date: Dec. 28, 2017

(54) MIGRATING DATA USING DUAL-PORT NON-VOLATILE DUAL IN-LINE MEMORY MODULES

(71) Applicant: HEWLETT PACKARD ENTERPRISE DEVELOPMENT LP, Houston, TX (US)

(72) Inventors: Dwight D. Riley, Houston, TX (US); Thierry Fevrier, Fort Collins, CO (US); Joseph E. Foster, Houston, TX (US)

(21) Appl. No.: 15/540,241

(22) PCT Filed: Apr. 30, 2015
(86) PCT No.: PCT/US2015/028623

§ 371 Date: Jun. 27, 2017

(51) Int. Cl. G06F 12/02; G06F 13/16; G06F 13/28; G06F 17/30

(52) U.S. Cl. CPC G06F 12/02; G06F 17/30215; G06F 13/16; G06F 13/28; G06F 2212/1032

(57) ABSTRACT

According to an example, a fabric manager server may migrate data stored in a dual-interface non-volatile dual in-line memory module (NVDIMM) of a memory application server. The fabric manager server may receive data routing preferences for a memory fabric and retrieve the data stored in universal memory of the dual-port NVDIMM according to the data routing preferences through a second port of the dual-port NVDIMM. The retrieved data may then be routed from the dual-port NVDIMM for replication to remote storage according to the data routing preferences. Once the retrieved data is replicated to remote storage, the fabric manager may alert the dual-port NVDIMM.

### BACKGROUND

A non-volatile dual in-line memory module (NVDIMM) is a computer memory module that can be integrated into the main memory of a computing platform. The NVDIMM, or the NVDIMM and a host server, may provide data retention when electrical power is removed due to an unexpected power loss, system crash, or a normal system shutdown. The NVDIMM, for example, may include universal or persistent memory to maintain data in the event of the power loss or fatal events.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a dual-port non-volatile dual in-line memory module (NVDIMM), according to an example of the present disclosure;

FIG. 2A shows a block diagram of a dual-port NVDIMM architecture, according to an example of the present disclosure;

FIG. 2B shows a block diagram of a fabric manager of a memory fabric that includes a dual-port NVDIMM, according to an example of the present disclosure;

FIG. 3 shows a block diagram of an active-passive implementation of the dual-port NVDIMM, according to an example of the present disclosure;

FIG. 4 shows a block diagram of memory fabric architecture including the active-passive implementation of the dual-port NVDIMM described in FIG. 3, according to an example of the present disclosure;

FIG. 5 shows a block diagram of an active-active implementation of the dual-port NVDIMM, according to an example of the present disclosure;

FIG. 6 shows a block diagram of an active-active implementation of the dual-port NVDIMM, according to another example of the present disclosure;

FIG. 7 shows a block diagram of memory fabric architecture including the active-active implementation of the dual-port NVDIMM, according to an example of the present disclosure;

FIG. 8 shows a flow diagram of a method to migrate data stored in a dual-port NVDIMM of a memory application server, according to an example of the present disclosure; and

FIG. 9 shows a schematic representation of a computing device, which may be employed to perform various functions of a CPU, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein are examples for migrating data using dual-port non-volatile dual in-line memory modules (NVDIMMs). A fabric manager server may setup, monitor, and orchestrate routing preferences a memory fabric. Particularly, the fabric manager server may receive data routing preferences for a memory fabric including dual-port NVDIMMs. The routing preferences may include a high-availability redundancy flow, an encryption policy, an expected performance metric, a memory allocation setting, etc. According to an example, the dual-port NVDIMMs may be mastered from either port. A port, for instance, is an interface or shared boundary across which two separate components of computer system may exchange information. The dual-port NVDIMM may include universal memory (e.g., persistent memory) such as memristor-based memory, magnetoresistive random-access memory (MRAM), bubble memory, racetrack memory, ferroelectric random-access memory (FRAM), phase-change memory (PCM), programmable metallization cell (PMC), resistive random-access memory (RRAM), Nano-RAM, and etc.

The dual-port NVDIMM may include a first port to provide a central processing unit (CPU) access to universal memory of the dual-port NVDIMM. In this regard, an operating system (OS) and/or an application program may master the dual-port NVDIMM through the first port. The dual-port NVDIMM may also include a second port to provide a NVDIMM manager circuit access to the universal memory of the dual-port NVDIMM. The NVDIMM manager circuit may interface with remote storage. In this regard, the fabric manager server may control the NVDIMM manager circuit to extract data from the universal memory of the dual-port NVDIMM via the second port to replicate the extracted data to remote storage according to a data routing preference. This replication, for example, is transparent to the CPU because it is implemented in hardware via the second port of the dual-port NVDIMM, thus bypassing at least one of an OS stack and a network stack. An OS stack may include for example an OS file system and application software high availability stacks on server message block (SMB) protocols on top of remote direct memory access (RDMA) fabrics. Thus, the disclosed examples remove these software layers from the CPU to optimize the performance of an application program. A network stack may include a network interface controller (NIC), such as a RDMA capable NIC.

According to an example, the fabric manager server may route the extracted data from the dual-port NVDIMM for replication to remote storage according to the data routing preferences. By replicating the extracted data to remote storage, the extracted data is thus made durable. Durable data is permanent, highly-available, and recoverable due to replication to remote storage. The remote storage may include, but is not limited to, an interconnect module bay of a blade enclosure or a memory array server and a replica memory application server of a memory fabric network. Once the extracted data is replicated to remote storage, the fabric manager server may alert the CPU via the dual-port NVDIMM that the extracted data has been transparently replicated to the remote storage and made durable.

With single-port NVDIMMs, when the CPU requests to store a transaction payload, the CPU has to block the transaction in order to move the bytes of the transaction payload from the single-port NVDIMM to a network OS-based driver stack. The OS-based driver stack then moves the bytes of the transaction payload to a remote storage, which stores the bytes in remote storage and transmits an acknowledgement to the CPU. Upon receiving the acknowledgement, the CPU may then finally unblock the transaction. As such, a user has to wait while the CPU replicates the transaction payload to remote storage for durability. Accordingly, implementing a high-availability model at the CPU or software level increases recovery time and may result in trapped data in event of a failure. High-availability models are designed to minimize system failures and handle specific failure modes for servers, such as memory application servers, so that access to the stored data is available at all times. Trapped data refers to data stored in the universal memory of NVDIMM that has not been made durable (i.e., has not been replicated to remote storage). With increases in recovery time and trapped data, users may be disappointed with the industry goals set for universal memory.

According to the disclosed examples, the dual-port NVDIMMs may be managed by a fabric manager server to implement high-availability models on a hardware level, which is transparent from the CPU. That is, the fabric manager server may perform a data migration transparently using the second port of the dual-port NVDIMM so that the CPU is not burdened with performing the time-consuming data migration steps discussed above with single-port NVDIMMs.

The disclosed examples provide the technical benefits and advantages of enhancing recovery time objectives and recovery data objectives for application programs and/or OSs. This allows application programs and/or OSs to benefit from the enhanced performance of universal memory while gaining resiliency in the platform hardware even in their most complex support of software high-availability. These benefits are achieved using a dual-port NVDIMM architecture that bridges legacy software architecture into a new realm where application programs and OSs have direct access to universal memory. For example, the disclosed dual-port NVDIMMs provide a hardware extension that may utilize system-on-chips (SOCs) to quickly move trapped NVDIMM data on a fabric channel between memory application servers. In other words, replication of data using the dual-port NVDIMMs may ensure that the trapped NVDIMM data is made durable in remote storage. The fabric channels of the disclosed examples may be dedicated or shared over a customized or a traditional network fabric (e.g., Ethernet). Thus, utilizing the replicating data using the dual-port NVDIMMs allows the fabric manager server to customize a fabric architecture to move data at hardware speeds between memory application servers in a blade enclosure, across racks, or between data centers to achieve enterprise class resiliency.

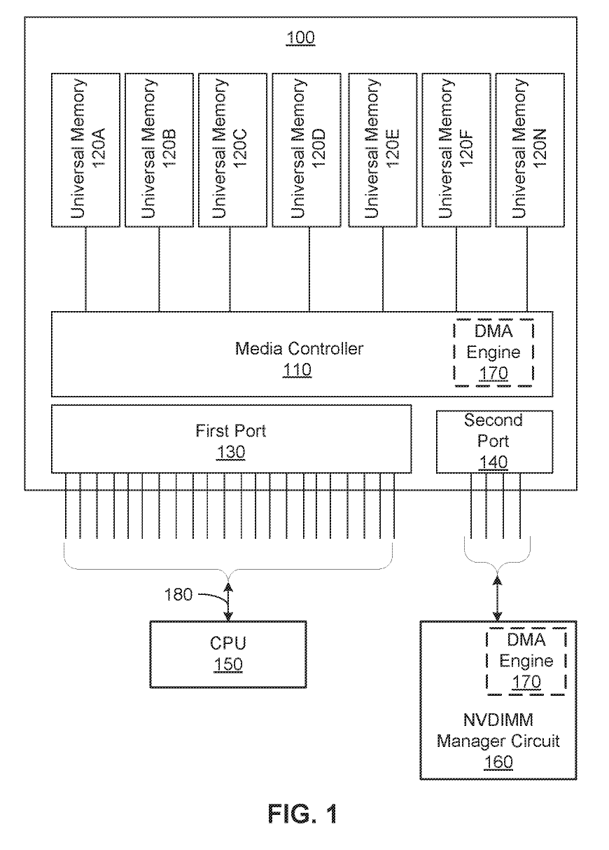

With reference to FIG. 1, there is shown a block diagram of a dual-port NVDIMM 100, according to an example of the present disclosure. It should be understood that the dual-port NVDIMM 100 may include additional components and that one or more of the components described herein may be removed and/or modified without departing from a scope of the dual-port NVDIMM 100. The dual-port NVDIMM 100 may include a media controller 110, universal memory 120A-N (where the number of universal memory components may be greater than or equal to one), a first port 130, and a second port 140.

The dual-port NVDIMM 100 is a computer memory module that can be integrated into the main memory of a computing platform. The dual-port NVDIMM 100 may be included in a memory application server that is part of a blade enclosure. The dual-port NVDIMM 100, for example, may include universal memory 120A-N (e.g., persistent) to maintain data in the event of the power loss. The universal memory may include, but is not limited to, memristor-based memory, magnetoresistive random-access memory (MRAM), bubble memory, racetrack memory, ferroelectric random-access memory (FRAM), phase-change memory (PCM), programmable metallization cell (PMC), resistive random-access memory (RRAM), Nano-RAM, and etc.

The media controller 110, for instance, may communicate with its associated universal memory 120A-N and control access to the universal memory 120A-N by a central processing unit (CPU) 150 and a NVDIMM manager circuit 160. For example, the media controller 110 may provide access to the universal memory 120A-N through the first port 130 and the second port 140. Each port, for instance, is an interface or shared boundary across which the CPU 150 and the NVDIMM manager circuit 160 may access regions of the universal memory 120A-N.

According to an example, the CPU 150 may access the universal memory 120A-N through the first port 130. The CPU 150 may be a microprocessor, a micro-controller, an application specific integrated circuit (ASIC), field programmable gate array (FPGA), or other type of circuit to perform various processing functions for a computing platform. In one example, the CPU 150 is a server. On behalf of an application program and/or operating system, for instance, the CPU 150 may generate sequences of primitives such as read, write, swap, etc. requests to the media controller 110 through the first port 130 of the dual-port NVDIMM 100.

According to an example, the NVDIMM manager circuit 160 may access the universal memory 120A-N through the second port 140. The NVDIMM manager circuit 160 is external to the dual-port NVDIMM 100 and interfaces to a network memory fabric via a fabric interface chip with network connections to remote storage in the network memory fabric, such as replica memory application servers and memory array servers. The NVDIMM manager circuit 160 may be a system on a chip (SOC) that integrates a processor core and memory into a single chip.

As discussed further in examples below, a direct memory access (DMA) engine 170 may be integrated into at least one of the media controller 110 or the NVDIMM manager circuit 160. The DMA engine 170, for example, may move the bytes of data between hardware subsystems independently of the CPU 150. The various components shown in FIG. 1 may be coupled by a fabric interconnect (e.g., bus) 180, where the fabric interconnect 180 may be a communication system that transfers data between the various components.

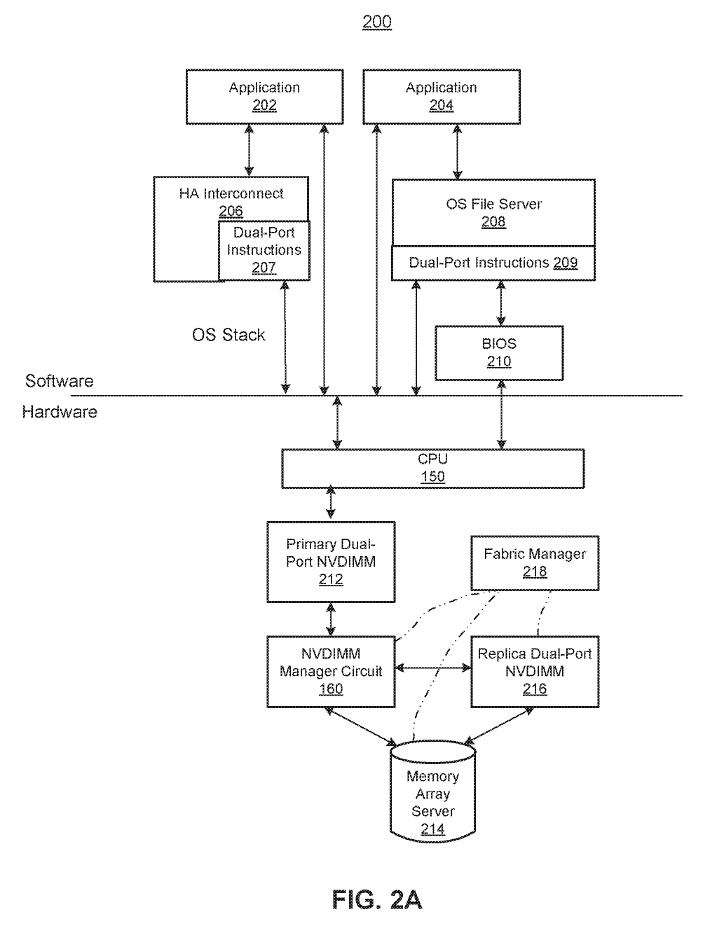

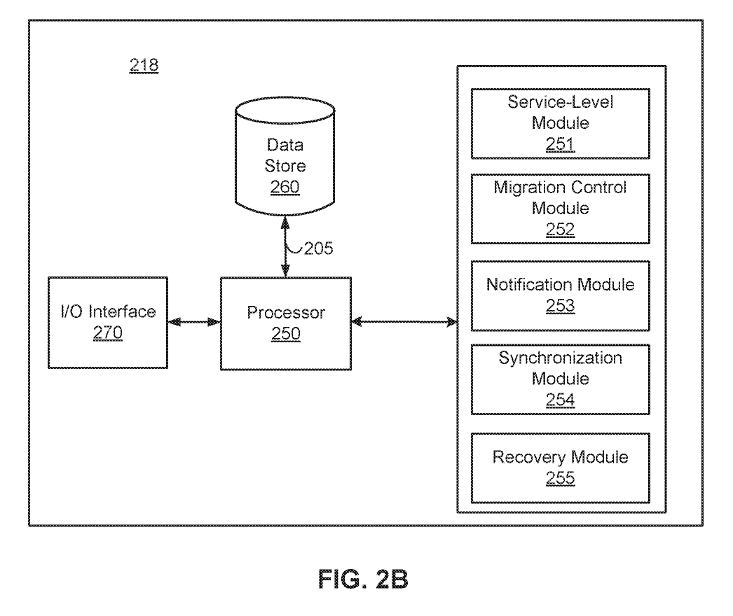

FIG. 2A shows a block diagram of a dual-port NVDIMM architecture 200, according to an example of the present disclosure. It should be understood that the dual-port NVDIMM architecture 200 may include additional components and that one or more of the components described herein may be removed and/or modified without departing from a scope of the dual-port NVDIMM architecture 200.

According to an example, the software side of the dual-port NVDIMM architecture 200 may include programs 202 and 204, a high-availability interconnect 206 (e.g., server message block (SMB) or remote direct memory access (RDMA)) with dual-port machine-readable instructions 207, an OS file system 208 with dual-port machine-readable instructions 209, and basic input/output system (BIOS) 210. The BIOS 210, for instance, may define memory pools and configurations for the dual-port NVDIMM architecture 200 and pass dual-port NVDIMM interface definitions to the OS file server 150. In this regard, the OS file server 150 may be aware of the high-availability capabilities of the dual-port in the NVDIMM architecture 200. For instance, the OS fileserver 150 may be aware that data stored on a dual-port NVDIMM may be transparently replicated to remote storage for durability. In this example, application program 204 may be a file system-only application that benefits from the dual-port machine-readable instructions 209 included in the aware OS fileserver 208. According to another example, the application program 202 may have received dual-port NVDIMM interface definitions from the CPU 150, and thus, be aware of the high-availability capabilities of the dual-port in the NVDIMM architecture 200. Thus, the byte-addressable application program 202 may benefit from the dual-port machine-readable instructions 207 included in an optimized high-availability interconnect 206 for the transparent replication of data to remote storage.

According to an example, the hardware side of the dual-port NVDIMM architecture 200 may include the CPU 150, a primary dual-port NVDIMM 212, a NVDIMM manager circuit 160, a memory array server 214, a replica dual-port NVDIMM, and a fabric manager 218. The CPU 150, may access a first port 130 of the primary dual-port NVDIMM 212 to issue a request to store data in universal memory and replicate the data to remote storage, such as the memory array server 214 and/or the replica dual-port NVDIMM 216, according to a high-availability capability request received from application programs 202 and 204. The NVDIMM manager circuit 160, for example, may extract the stored data from a second port 140 of the primary dual-port NVDIMM 212 as instructed by the fabric manager 218. The fabric manager 281 may setup, monitor, and orchestrate a selected high-availability capability for the dual-port architecture 200 as further described below. For example, the fabric manager 420 may control the NVDIMM manager circuit 160 to route the extracted data between the primary dual-port NVDIMM 212, the memory array server 214, and the replica dual-port NVDIMM 216 to establish a durable and data-safe dual-port NVDIMM architecture 200 with high-availability redundancy and access performance enhancements.

FIG. 2B shows a block diagram of a fabric manager 218 for a memory fabric that includes a dual-port NVDIMM, according to an example of the present disclosure. It should be understood that the fabric manager 218 may include additional components and that one or more of the components described herein may be removed and/or modified without departing from a scope of the fabric manager 218. The fabric manager 218 may include a processor 250, a data store 260, and an input/output (I/O) interface 270.

The components of the fabric manager 218 are shown on a single computer server as an example and in other examples the components may exist on multiple computer servers. The fabric manager 218 may store or manage data in an internal or external data store 260. The data store 260 may include physical memory such as a hard drive, an optical drive, a flash drive, an array of drives, or any combinations thereof, and may include volatile and/or non-volatile data storage. The processor 250 may be coupled to the data store 260 and the I/O interface 270 by a bus 205, where the bus 205 may be a communication system that transfers data between various components of the fabric manager 218. In examples, the bus 205 may be a Peripheral Component Interconnect (PCI), Industry Standard Architecture (ISA), PCI-Express, HyperTransport®, NuBus, a proprietary bus, and the like. The I/O interface 270 may include an out-of-band management (OOB) or lights-out management (LOM) interface for managing network devices.

The processor 102, which may be a microprocessor, a micro-controller, an application specific integrated circuit (ASIC), or the like, is to perform various processing functions in fabric manager 218. According to an example, the processor 250 may process the functions of a service-level module 251, a migration control module 252, a notification module 253, a synchronization module 254, and a recovery module 255.

The service-level module 251 may receive data routing preferences for a memory fabric. The migration control module 254 may retrieve the data stored in universal memory of the dual-port NVDIMM 100 though a second port 140 of the dual-port NVDIMM 100 according to the data routing preferences in order to transparently bypass at least one of an operating system stack and a network stack of the CPU 150. The migration control module 252 may also route the retrieved data from the dual-port NVDIMM 100 for replication to remote storage according to the data routing preferences. The notification module 253 may alert the media controller 110 of the dual-port NVDIMM 100 when the retrieved data is replicated to the remote storage. The synchronization module 254 may coordinate updates to the replicated data between dual-port NVDIMM 100 and each of the remote storage in the memory fabric. The recovery module 255 may retrieve the replicated data from the remote storage in response to a predetermined condition, and transmit the replicated data to the universal memory of another dual-port NVDIMM 100 of another memory application server. The predetermined condition, for example, may be a condition where the primary memory application server of the dual-port NVDIMM experiences an unexpected power loss, system crash, or a normal system shutdown. In this regard, the original data stored in the dual-port NVDIMM of the primary application server may be retrieved by other memory application servers, and is therefore the original data is not trapped in the dual-port NVDIMM of the primary application server according to the disclosed examples.

Modules 251-255 of the fabric manager 218 are discussed in greater detail below. In this example, modules 251-255 are circuits implemented in hardware. In another example, the functions of modules 251-255 may be machine readable instructions stored on a non-transitory computer readable medium and executed by a processor 250, as discussed further below.

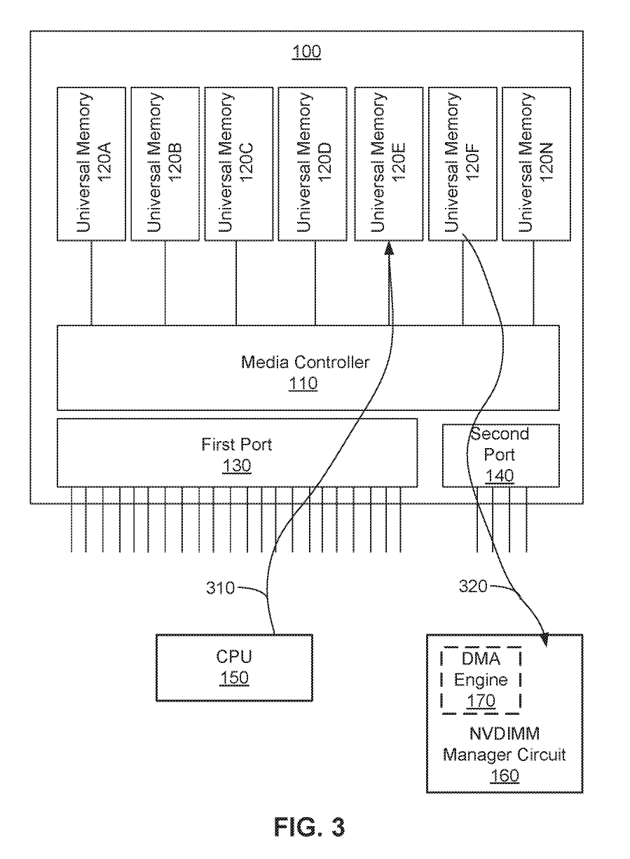

FIG. 3 shows a block diagram of an active-passive implementation of the dual-port NVDIMM 100, according to an example of the present disclosure. In this implementation of the dual-port NVDIMM 100, the DMA engine 170 is external from the dual-port NVDIMM 100 and integrated with the NVDIMM manager circuit 160. The CPU 150 may issue requests as shown in arc 310 to the media controller through the first port 130. For example, the CPU 150 may issue requests including a write request to store data in the universal memory 120A-N, a commit request to replicate data to remote storage, and a dual-port setting request through the first port 130. The dual-port setting request may include a request for the media controller 110 to set the first port 130 of the dual-port NVDIMM 110 to an active state so that the CPU 150 can actively access the dual-port NVDIMM 100 and set the second port 140 of the dual-port NVDIMM 100 to a passive state to designate the NVDIMM manager circuit 160 as a standby failover server.

According to this example, the media controller 110 may receive a request from the external DMA engine 170 at a predetermined trigger time to retrieve the stored data in the universal memory 120A-N and transmit the stored data to the external DMA engine 170 through the passive second port 140 of the dual-port NVDIMM as shown in arc 320. The external DMA engine 170 may then make the stored data durable by creating an offline copy of the stored data in remote storage via the NVDIMM Manager Circuit 160.

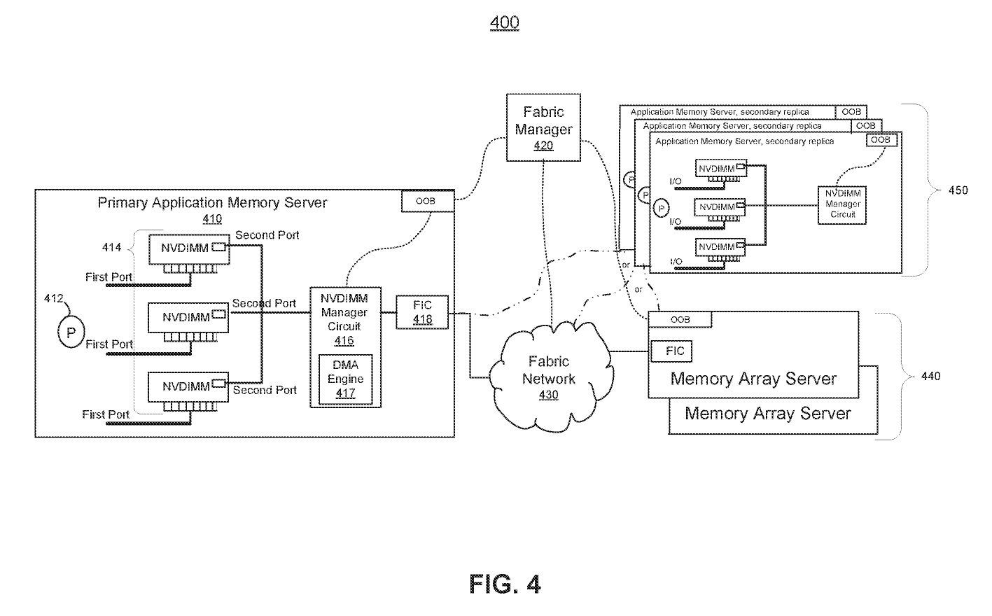

FIG. 4 shows a block diagram of memory fabric architecture 400 including the active-passive implementation of the dual-port NVDIMM 100 described in FIG. 3, according to an example of the present disclosure. It should be understood that the memory fabric architecture 400 may include additional components and that one or more of the components described herein may be removed and/or modified without departing from a scope of the memory fabric architecture 400. The memory fabric architecture 400 may include a primary application memory server 410, a memory fabric manager 420, fabric network 430, memory array server 440, and secondary replica application memory servers 450, which are read-only application memory servers.

The primary application memory server 410 may include a processor 412, dual-port NVDIMMs 414, a NVDIMM manager circuit 416, and a fabric interconnect chip (FIC) 418. The processor 412 may, for example, be the CPU 150 discussed above. The processor 412, via the first ports of the dual-port NVDIMMs 414, may issue a request to store data in universal memory and commit data to remote storage, and further request that the second ports of the dual-port NVDIMMs 414 are set to a passive state to designate the NVDIMM manager circuit 416 as a standby failover server. The NVDIMM manager circuit 416 may, for example, be the NVDIMM manager circuit 160 discussed above. In this memory fabric architecture 400, the DMA engine 417 is integrated with the NVDIMM manager circuit 416. The DMA engine 417 of the NVDIMM manager circuit 416 may access the dual-port NVDIMMs 414 through their second ports to retrieve stored data at a predetermined trigger time. The DMA engine 417 may then move the bytes of retrieved data to remote storage via the FIC 418 and the fabric network 430 to create a durable offline copy of the stored data in remote storage, such as the memory array servers 440 and/or the secondary replica application memory servers 450. Once a durable offline copy is created in remote storage, the CPU 150 may be notified by the media controller 110.

According to an example, the primary application memory server 410 may pass to the fabric manager 420 parameters via out-of-band (OOB) management channels. These parameters may include parameters associated with the encryption and management of the encrypting keys on the fabric network 430 and/or the memory array servers 440. These parameters may also include high-availability attributes and capacities (e.g., static or dynamic) and access requirements (e.g., expected latencies, queue depths, etc.) according to service level agreements (SLAs) provided by the dual-port NVDIMMs 414, the fabric manager 420, and memory array servers 440.

The fabric manager 420 may setup, monitor, and orchestrate a selected high-availability capability for the memory fabric architecture 400. For example, the fabric manager 420 may manage universal memory ranges from the memory array servers 440 in coordination with the application memory servers that are executing the high-availability capabilities that are enabled for the dual-port NVDIMMs 414. The fabric manager 420 may commit memory ranges on the memory array servers 440. These committed memory ranges may be encrypted, compressed, or even parsed for storage and access optimizations. The fabric manager 420 may transmit event notifications of the memory array servers 440 to the application memory servers in the memory fabric. According to other examples, the fabric manager 440 may migrate the committed memory ranges to other memory array servers, synchronize updates to all of the application memory servers (e.g., primary 410 and secondary 450) in the fabric network 430 with the memory array servers 440, and may control whether the memory array servers 440 are shared or non-shared in the fabric network 430.

According to an example, the NVDIMM manager circuit 416 may use the network fabric 430, in synchronization with the fabric manager 420, to move a data working set with possible optimizations (e.g., encryption and compression) to the selected memory array servers 440. According to another example, under the control of the fabric manager 420, the connections to the secondary replica application memory servers 450 (e.g., other memory application servers or rack of memory application servers that act as a secondary replica of the primary application memory server 410) are established in a durable and data-safe way to provide another level of high-availability redundancy and access performance enhancements.

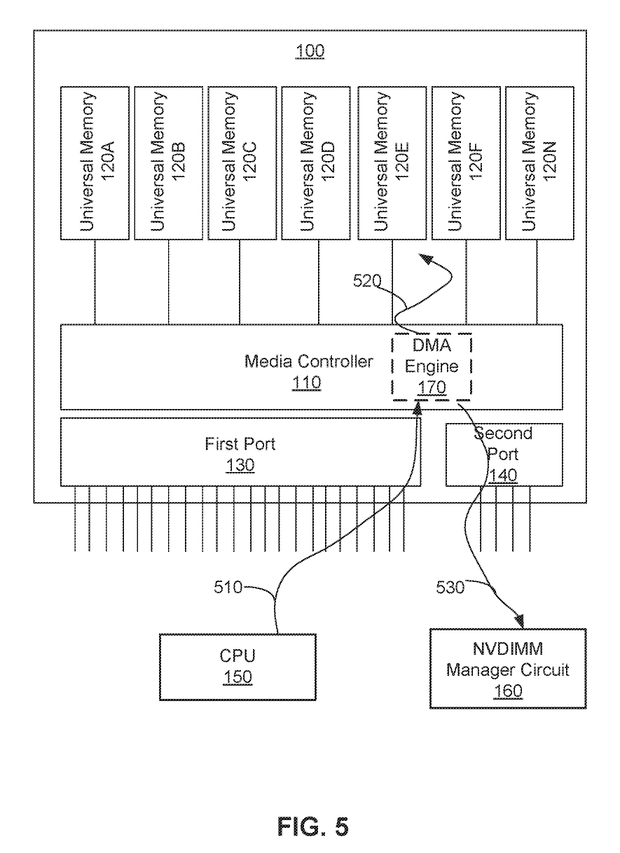

FIG. 5 shows a block diagram of an active-active implementation of the dual-port NVDIMM 100, according to an example of the present disclosure. In this implementation of the dual-port NVDIMM 100, the DMA engine 170 integrated with the media controller 110. The CPU 150 may issue requests as shown in arc 510 to the media controller 110 through the first port 130. For example, the CPU 150 may issue requests including a write request to store data in the universal memory 120A-N, a request to commit the data to remote storage, and a dual-port setting request through the first port 130. The dual-port setting request may include a request for the media controller 110 to set the first port 130 of the dual-port NVDIMM 110 and the second port 140 of the dual-port NVDIMM 100 to active state so that the CPU 150 and the NVDIMM manager circuit 160 may access the dual-port NVDIMM 100 simultaneously.

According to this example, the integrated DMA engine 170 of the media controller 110 may store the received data to universal memory 120A-N as shown in arc 520 and automatically move the bytes of the data to the NVDIMM manager circuit 160 in real-time through the active second port 140 as shown in arc 530 to replicate the data to in remote storage. Once a durable copy of the data is created in remote storage, the CPU 150 may be notified by the media controller 110.

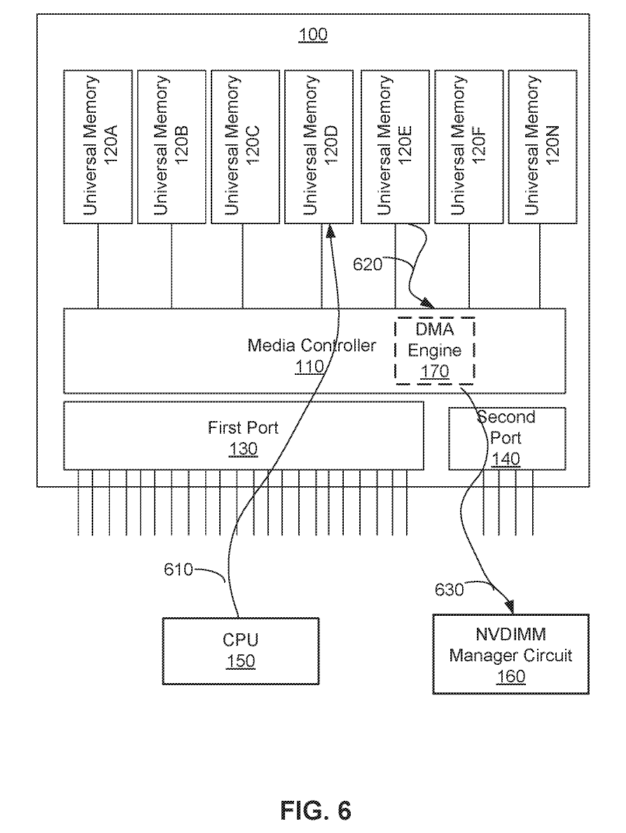

FIG. 6 shows a block diagram of an active-active implementation of the dual-port NVDIMM 100, according to another example of the present disclosure. In this implementation of the dual-port NVDIMM 100, the DMA engine 170 is also integrated with the media controller 110. The CPU 150 may issue requests as shown in arc 610 to the media controller 110 through the first port 130. For example, the CPU 150 may issue requests including a write request to store data in the universal memory 120A-N, a request to commit the data to remote storage, and a dual-port setting request through the first port 130. The dual-port setting request may include a request for the media controller 110 to set the first port 130 of the dual-port NVDIMM 110 and the second port 140 of the dual-port NVDIMM 100 to active state so that the CPU 150 and the NVDIMM manager circuit 160 may access the dual-port NVDIMM 100 simultaneously.

According to this example, however, the integrated DMA engine 170 does not replicate the data received from the CPU in real-time. Instead, integrated DMA engine 170 of the memory controller 110 may retrieve the stored data in the universal memory 120A-N at a predetermined trigger time as shown in arc 620. In this regard, the integrated DMA engine 170 may transmit the stored data through the passive second port 140 of the dual-port NVDIMM to the NVDIMM manager circuit 160 as shown in arc 330 to replicate the data in remote storage. Once a durable copy of the data is created in remote storage, the CPU 150 may be notified by the media controller 110.

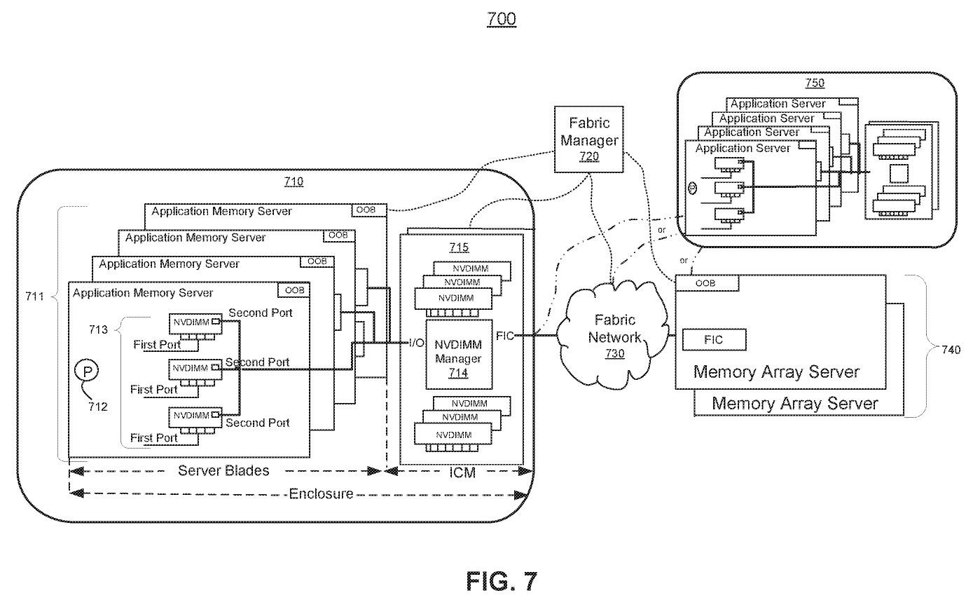

FIG. 7 shows a block diagram of memory fabric architecture 700 including the active-active implementation of the dual-port NVDIMM 100 described in FIGS. 5 and 6, according to an example of the present disclosure. It should be understood that the memory fabric architecture 700 may include additional components and that one or more of the components described herein may be removed and/or modified without departing from a scope of the memory fabric architecture 700. The memory fabric architecture 700 may include a primary blade enclosure 710, a memory fabric manager 720, fabric network 730, memory array server 740, and secondary blade enclosure 750.

The primary blade enclosure may include server blades comprising a plurality of application memory servers 711. Each of the plurality of application memory servers 711 may include a processor 712 and dual-port NVDIMMs 713. The processor 712 may, for example, be the CPU 150 discussed above. In this example, the dual-port NVDIMMs 713 each have a DMA engine integrated within their memory controller. The processor 712, via the first ports of the dual-port NVDIMMs 713, may issue a request to store data in universal memory, a request to commit the data to remote storage, and a request that the second ports of the dual-port NVDIMMs 711 be set to an active state to allow the NVDIMM manager circuit 714 of the interconnect bay module (ICM) 715 simultaneous access to the dual-port NVDIMMs 711. The NVDIMM manager circuit 714 is integrated in the ICM 715 of the memory blade enclosure 710. The ICM 715, for example, may also include dual-port NVDIMMs for storage within the ICM 715.

In this example, the DMA engines, which are integrated within the media controllers of each of the plurality of dual-port NVDIMMs 713 of the application memory servers 711, may automatically move the bytes of data received from the processor 712 to the NVDIMM manager 714 through the active second ports of the dual-port NVDIMMs 713 in real-time for replication to the dual-port NVDIMMs on the ICM 715. According to another example, the DMA engines may instead trigger, at a predetermined time, the migration of the stored data to the NVDIMM manager 714 through the active second ports for replication to the dual-port NVDIMMs on the ICM 715. In both examples, once a durable copy of the data is created in remote storage, the CPU 150 may be notified by the media controller 110.

The memory fabric architecture 700 is a tiered solution where the ICM 715 may be used to quickly replicate data off of the plurality of memory application servers 711. This tiered solution allows replicated data to be stored within the primary memory blade enclosure 710. As a result of replicating data replication within the ICM bay 715 (but remote from the plurality of memory application servers 711), the replicated data can be managed and controlled as durable storage. With durable data stored in the blade memory enclosure 710, a tightly coupled local-centric, high-availability domain (e.g., an active-active redundant application memory server solution within the enclosure) is possible.

According to an example, the NVDIMM manager 714 may, in concert with the fabric manager 720, further replicate the stored data to the memory array server 740 and the secondary blade enclosure 750 via the fabric network 730 to provide another level of high-availability redundancy and access performance enhancements in the memory fabric architecture 700. The functions of the fabric manager 720, fabric network 730, memory array servers 740, and secondary blade enclosure 750 are similar to that of the fabric manager 420, fabric network 430, memory array server 440, and secondary replica application memory servers 450 discussed above in FIG. 4.

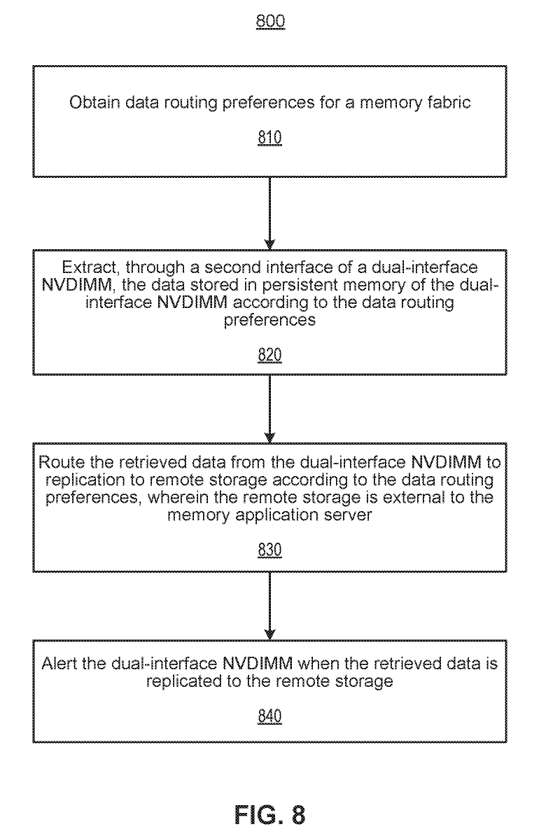

With reference to FIG. 8, there is shown a flow diagram of a method 800 to migrate data stored in a dual-port NVDIMM of a memory application server, according to an example of the present disclosure. It should be apparent to those of ordinary skill in the art that method 800 represents generalized illustrations and that other sequences may be added or existing sequences may be removed, modified or rearranged without departing from the scope of the method.

In block 810, the service-level module 251 may obtain data routing preferences for a memory fabric. The routing preferences may include a high-availability redundancy flow (e.g., active-active redundancy flow, active-passive redundancy flow, etc.), an encryption policy (e.g., encryption keys for each server in the memory fabric), an expected performance metric (e.g., latencies, queue depths, etc.), and a memory allocation setting (e.g., dynamic, static, shared, non-shared, etc.). According to an example, the data routing preferences may be cached between the fabric manager and the NVDIMM manager circuit.

In block 820, the migration control module 252 may extract, through a second interface of the dual-interface NVDIMM, the data stored in persistent memory of the dual-interface NVDIMM according to the data routing preferences obtained by the service-level module 251. By extracting the data through a second interface of the dual-interface NVDIMM, the data may be extracted transparently from a central processing unit (CPU) of the memory application server. In this regard, the migration or replication of the data may bypass at least one of an operating system stack and a network stack of the CPU according to the disclosed examples.

In block 830, the migration control module 252 may route the retrieved data from the dual-interface NVDIMM to replicate the data to remote storage according to the data routing preferences. As noted above, the remote storage may be external to the memory application server according to an example. The remote storage may include a memory array server, a replica memory application server, a persistent storage in an interconnect module bay of a blade memory enclosure, etc. According to an example, the migration control module 252 may route the retrieved data to a designated memory range of the memory array server. In block 840, the notification module 253 may alert the dual-interface NVDIMM and the CPU via the first port when the retrieved data is replicated to the remote storage.

According to an example, the synchronization module 254 may synchronize all updates or modifications to the replicated data between the memory application server and all of the remote storage in the memory fabric. According to another example, the recovery module 255 may retrieve the replicated data from the remote storage in response to a predetermined condition, and transmit the replicated data to a requesting dual-port NVDIMM of another memory application server. The predetermined condition, for example, may be a condition where the primary memory application server of the dual-port NVDIMM experiences an unexpected power loss, system crash, or a normal system shutdown. In this regard, the original data stored in the dual-port NVDIMM of the primary application server may be retrieved by other memory application servers, and is therefore the original data is not trapped in the dual-port NVDIMM of the primary application server according to the disclosed examples.

Some or all of the operations set forth in the method 800 may be contained as utilities, programs, or subprograms, in any desired computer accessible medium. In addition, method 800 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

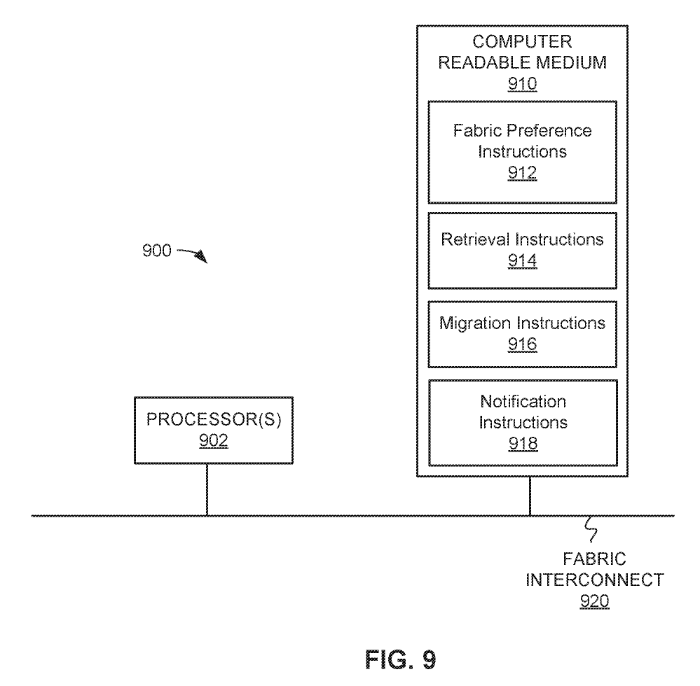

Turning now to FIG. 9, a schematic representation of a computing device 900, which may be employed to perform various functions of the fabric manager server 218, is shown according to an example implementation. The device 900 may include a processor 902 coupled to a computer-readable medium 910 by a fabric interconnect 920. The computer readable medium 910 may be any suitable medium that participates in providing instructions to the controller 902 for execution. For example, the computer readable medium 910 may be non-volatile media, such as an optical or a magnetic disk; volatile media, such as memory.

The computer-readable medium 910 may store instructions to perform method 800. For example, the computer-readable medium 910 may include machine readable instructions such as fabric preference instructions 912 to receive data migration preferences for a memory fabric; retrieval instructions 914 to retrieve the data stored in universal memory of the dual-port NVDIMM according to the fabric preference instructions 912; migration instructions 916 to migrate the retrieved data from the dual-port NVDIMM to commit to remote storage that is external to the memory application server according to the fabric preference instructions 912; and notification instructions 918 to notify the dual-port NVDIMM when the retrieved data is committed to the remote storage. Accordingly, the computer-readable medium 910 may include machine readable instructions to perform method 800 when executed by the processor 902.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A fabric server to migrate data stored in a dual-port non-volatile dual in-line memory module (NVDIMM) of a memory application server, comprising:
a memory storing machine readable instructions;
a processor to implement the machine readable instructions, the processor including:
a service-level module to receive data routing preferences for a memory fabric;
a migration control module to
retrieve the data stored in universal memory of the dual-port NVDIMM according to the data routing preferences, wherein the data is retrieved from a second port of the dual-port NVDIMM, and
route the retrieved data from the dual-port NVDIMM for replication to remote storage that is external to the memory application server according to the data routing preferences; and
a notification module to alert the dual-port NVDIMM when the retrieved data is replicated to the remote storage.

2. The fabric server of claim 1, wherein to retrieve the data and to route the retrieved data, the migration control module is to:
migrate the data to the remote storage transparently from a central processing unit (CPU) of the memory application server that accesses a first port of the dual-port NVDIMM, wherein to transparently migrate the data, the migration control module is to bypass at least one of an operating system stack and a network stack of the CPU.

3. The fabric server of claim 1, wherein the service-level module is to receive routing preferences including at least one of a high-availability redundancy flow, an encryption policy, an expected performance metric, and a memory allocation setting.

4. The fabric server of claim 1, wherein the remote storage includes at least one of a memory array server, a replica memory application server, and persistent storage in an interconnect module bay of a blade memory enclosure.

5. The fabric server of claim 4, wherein to route the retrieved data from the dual-port NVDIMM to remote storage, the migration control module is to replicate the retrieved data to a designated memory range of the memory array server.

6. The fabric server of claim 1, comprising a synchronization module to coordinate updates to the replicated data between the memory application server and each of the remote storage in the memory fabric.

7. The fabric server of claim 1, comprising a recovery module to:
retrieve the replicated data from the remote storage in response to a predetermined condition; and
transmit the replicated data to universal memory of another requesting dual-port NVDIMM of another memory application server.

8. A method to migrate data stored in a dual-interface non-volatile dual in-line memory module (NVDIMM) of a memory application server, comprising:
obtaining, by a processor of a fabric server, data routing preferences for a memory fabric;
extracting, through a second interface of the dual-interface NVDIMM, the data stored in persistent memory of the dual-interface NVDIMM according to the data routing preferences;
routing the retrieved data from the dual-interface NVDIMM to replication to remote storage according to the data routing preferences, wherein the remote storage is external to the memory application server; and
alerting the dual-interface NVDIMM when the retrieved data is replicated to the remote storage.

9. The method of claim 8, wherein extracting the data comprises extracting the data transparently from a central processing unit (CPU) of the memory application server through a second interface of the dual-interface NVDIMM to bypass at least one of an operating system stack and a network stack of the CPU.

10. The method of claim 8, wherein the routing preferences include at least one of a high-availability redundancy flow, an encryption policy, an expected performance metric, and a memory allocation setting.

11. The method of claim 8, wherein the remote storage includes at least one of a memory array server, a replica memory application server, and persistent storage in an interconnect module bay of a blade memory enclosure.

12. The method of claim 11, wherein routing the retrieved data from the dual-interface NVDIMM to remote storage includes replicating the retrieved data to a designated memory range of the memory array server.

13. The method of claim 8, comprising synchronizing updates to the replicated data between the memory application server and each of the remote storage in the memory fabric.

14. The method of claim 8, comprising:
retrieving the replicated data from the remote storage in response to a predetermined condition; and
transmitting the replicated data to persistent memory of another requesting dual-interface NVDIMM of another memory application server.

15. A non-transitory computer readable medium to migrate data stored in a dual-interface non-volatile dual in-line memory module (NVDIMM) of a memory application server, including machine readable instructions executable by a processor to:
receive data migration preferences for a memory fabric;
retrieve the data stored in universal memory of the dual-port NVDIMM according to the data migration preferences, wherein the data is retrieved from a second port of the dual-port NVDIMM to bypass at least one of an operating system stack and a network stack of a central processing unit (CPU) of the memory application server;
migrate the retrieved data from the dual-port NVDIMM to commit to remote storage that is external to the memory application server according to the data migration preferences; and
notify the dual-port NVDIMM when the retrieved data is committed to the remote storage.
